(19) United States
(12) Patent Application Publication
(10) Pub. No.: US 2024/0217514 A1
(43) Pub. Date: Jul. 4, 2024

(54) VEHICLE CONTROL DEVICE

(71) Applicant: TOYOTA JIDOSHA KABUSHIKI KAISHA, Toyota-shi (JP)

(72) Inventor: Kaori YAMADA, Nagakute-shi (JP)

(73) Assignee: TOYOTA JIDOSHA KABUSHIKI KAISHA, Toyota-shi (JP)

(21) Appl. No.: 18/508,960

(22) Filed: Nov. 14, 2023

(30) Foreign Application Priority Data
Dec. 28, 2022 (JP) 2022-212692

(51) Int. Cl. B60W 30/16; B60W 50/14

(52) U.S. Cl. CPC B60W 30/16; B60W 50/14; B60W 2520/06; B60W 2520/10; B60W 2554/802; B60W 2555/20; B60W 2556/50

(57) ABSTRACT

A vehicle control device mounted on a vehicle includes a control unit. The control unit is configured to be able to acquire road map information, position information indicating a position of the vehicle, a traveling direction of the vehicle, speed information of the vehicle, and traffic information. When the traffic information including the information on the occurrence position of the traffic disturbance is acquired, the control unit determines whether or not the occurrence position is on the route on which the vehicle travels, based on the road map information, the position information, and the traveling direction. The control unit is configured to execute a process of calculating a reference inter-vehicle distance based on the distance between the position of the vehicle and the occurrence position and the speed information.

### CROSS-REFERENCE TO RELATED APPLICATION

This application claims priority to Japanese Patent Application No. 2022-212692 filed on Dec. 28, 2022, incorporated herein by reference in its entirety.

### BACKGROUND

### 1. Technical Field

The present disclosure relates to a vehicle control device.

### 2. Description of Related Art

Conventionally, a device that warns of an approach to a preceding vehicle is known. For example, there has been proposed a device that gives a warning to a driver when the host vehicle is approaching the preceding vehicle based on the relative speed, which is the speed of the host vehicle with respect to the speed of the preceding vehicle, and the inter-vehicle distance with respect to the preceding vehicle (for example, refer to Japanese Unexamined Patent Application Publication No. 2021-054133 (JP 2021-054133 A)).

### SUMMARY

However, according to the related art, since the congestion information and the like are not taken into consideration, a rapid deceleration may be required. The related art has room for improvement in the method of determining the inter-vehicle distance.

An object of the present disclosure made in view of such circumstances is to improve safety when a deceleration of a traveling speed occurs due to a traffic disturbance.

A vehicle control device according to an embodiment of the present disclosure that solves the above problem is a vehicle control device mounted on a vehicle. A vehicle control device includes a control unit. The control unit is configured to be able to acquire a road map information, position information indicating a position of the vehicle, a traveling direction of the vehicle, speed information of the vehicle, and traffic information. The control unit determines, when acquiring the traffic information including information of an occurrence position of a traffic disturbance, whether the occurrence position is on a route on which the vehicle travels, based on the road map information, the position information, and the traveling direction. Further, the control unit is configured to execute a process of calculating a reference inter-vehicle distance based on a distance between the position of the vehicle and the occurrence position, and the speed information.

According to the present disclosure, it is possible to improve safety by presenting an appropriate inter-vehicle distance to a driver when a deceleration of a traveling speed occurs due to a traffic disturbance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a vehicle including a vehicle control device according to an embodiment of the present disclosure;

FIG. 2 is a block diagram illustrating a system for providing traffic information to the vehicle of FIG. 1;

FIG. 3 is a diagram for explaining information transmission when a traffic disturbance occurs and a method for controlling a vehicle; and

FIG. 4 is a flowchart illustrating a process executed by the vehicle control device.

### DETAILED DESCRIPTION OF EMBODIMENTS

Hereinafter, an embodiment of the present disclosure will be described below with reference to the drawings. Note that the drawings used in the following description are schematic. Dimensions, ratios, and the like in the drawings do not necessarily coincide with actual ones.

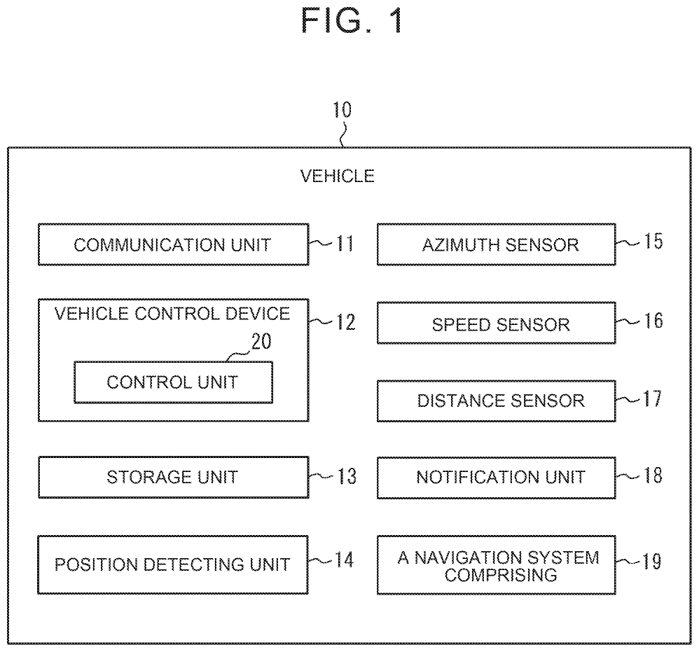

With reference to FIG. 1, a configuration of a vehicle 10 equipped with the vehicle control device 12 of the present disclosure will be described. In the vehicle control device 12 of the present disclosure, when a traffic disturbance occurs in front of a route on which the vehicle 10 is traveling, a driver is warned and/or a speed is controlled in advance before the traffic on the road on which the vehicle is traveling is affected. For example, the vehicle control device 12 increases the inter-vehicle distance before the deceleration of the vehicle 10 occurs due to the influence of the traffic disturbance generated in front of the traveling route. Here, the traffic disturbance includes at least one of a traffic jam, a road obstacle, a road construction, an accident, a road surface freezing, rainfall, snow accumulation, and a thick fog.

As illustrated in FIG. 1, the vehicle 10 includes a communication unit 11, a vehicle control device 12, a storage unit 13, a position detection unit 14, an azimuth sensor 15, a speed sensor 16, a distance sensor 17, and a notification unit 18. The vehicle 10 may further include a navigation system 19. The vehicle control device 12 includes a control unit 20. The communication unit 11 and the storage unit 13 may be included in the vehicle control device 12 as part of the vehicle control device 12.

In the present application, the vehicle 10 includes, but is not limited to, a passenger car, a truck, a bus, a large and small special motor vehicle, and the like. Vehicle 10 includes various types of vehicles that may be realized in the future.

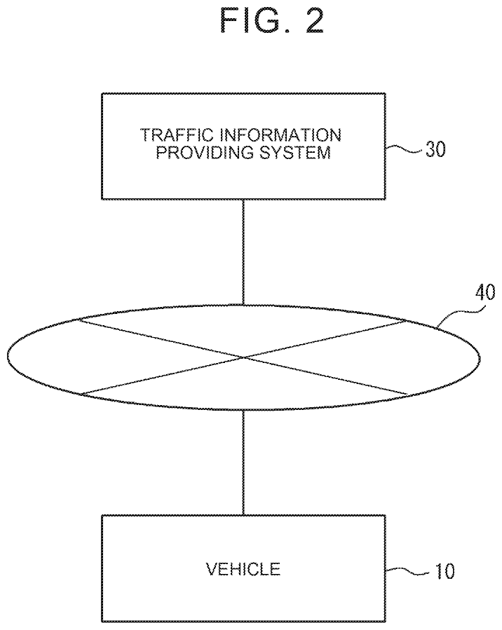

The communication unit 11 includes at least one external communication interface for communicating with an external information processing apparatus, an external device, an external vehicle, and the like. The external communication interface is, for example, an interface compatible with a mobile communication standard such as a Long Term Evolution (LTE), a fourth-generation mobile communication system (4G), or a fifth-generation mobile communication system (5G). The vehicle 10 can be connected to the network 40 illustrated in FIG. 2 by the communication unit 11. The vehicle 10 may communicate with a traffic information providing system 30 that provides traffic information via a network 40.

The communication unit 11 can receive information transmitted in one direction from the traffic information providing system 30 instead of bidirectional communication. For example, the communication unit 11 may receive traffic information transmitted by being superimposed on a broadcast wave such as FM multiplex broadcast. In addition, the communication unit 11 may correspond to a communication technique using microwaves such as Dedicated Short Range Communications (DSRC) and/or a transmission/reception method of traffic information using optical communication such as near infrared rays. The communication unit 11 can correspond to any communication technology used at present and in the future as long as it is a technology for transmitting and receiving traffic information.

The vehicle control device 12 executes various controls related to traveling of the vehicle 10. The vehicle control device 12 includes a control unit 20. The control unit 20 is configured to include a single processor or a plurality of processors and a memory. The processor includes a general purpose processor configured to execute a programmed function by reading a specific program and a special purpose processor specialized in a specific process. Dedicated processors may include Digital Signal Processor (DSP), Application Specific Integrated Circuit (ASIC), and Field-Programmable Gate Array (FPGA). The memory can store a program executed by the processor, information being calculated by the processor, and the like. The memory and the processor are connected to each other by a bus line such as a data bus and a control bus. The memory may include read-only memory (ROM), Random Access Memory (RAM), flash memory, etc. RAM may include Dynamic Random Access Memory (DRAM) and Static Random Access Memory (SRAM).

The storage unit 13 includes a semiconductor storage device, a magnetic storage device, and an optical storage device. The semiconductor memory device includes a Solid State Drive (SSD) using a flash memory and the like. The magnetic storage device includes a magnetic tape, a floppy (registered trademark) disk, a hard disk and the like, and drive devices thereof. Optical storage devices include, for example, Compact Disc (CD), Digital Versatile Disc (DVD), Blu-ray, and the like, and drives thereof. The memory or memories included in the storage unit 13 may each function as a main storage, an auxiliary storage, or a cache memory, for example. The storage unit 13 stores arbitrary information which is used for operation of the vehicle 10. For example, the storage unit 13 may store a program for operating the vehicle control device 12. Further, the storage unit 13 stores road map information including a road on which the vehicle 10 travels.

The position detection unit 14 detects an absolute position (latitude, longitude, and the like) as the position information of the vehicle 10. The position detection unit 14 includes a Global Positioning System (GPS) receiver. The position detection unit 14 can obtain the latitude and longitude of the present position of the vehicle 10 by using the signal from GPS receiving device. GPS uses satellites to measure the position of the vehicle 10. Note that a receiver corresponding to another Global Navigation Satellite System (GNSS) may be adopted instead of GPS receiver or in addition to GPS receiver. The other GNSS includes a satellite positioning system using a quasi-zenith satellite, for example. The position detection unit 14 can estimate the current position using the azimuth sensor 15 and the speed sensor 16, which will be described later, where the current position cannot be received by GPS receiving device. The position detection unit 14 can map the position of the vehicle 10 on the road map information stored in the storage unit 13.

The azimuth sensor 15 detects the current orientation of the vehicle 10. The azimuth sensor 15 includes a geomagnetic sensor that detects geomagnetism and obtains an azimuth. Further, a gyro sensor, a wheel sensor, or the like may be used as the azimuth sensor 15. The gyro sensor includes a gas rate gyro that detects a rotational angular velocity of the vehicle 10 and integrates the angular velocity to obtain an azimuth of the vehicle 10, an optical fiber gyro, and the like. The wheel sensor calculates the displacement amount of the azimuth by arranging the left and right wheel sensors and detecting the turning of the vehicle 10 based on the output pulse difference (difference in travel distance).

The speed sensor 16 is a sensor that detects a traveling speed of the vehicle 10. The speed sensor 16 measures the rotational speed of the axle, for example, and calculates the vehicle speed by multiplying the rotational speed by the outer circumference of the tire.

The distance sensor 17 is a sensor that measures a distance to an object in front of the vehicle 10. In the present application, the object in front is another vehicle that travels in front of the vehicle 10. The distance sensor 17 includes a Light Detection and Ranging (LIDAR), a millimeter-wave radar, a laser radar, an ultrasonic sensor, and a stereo camera. Any one or more of these devices may be employed as the distance sensor 17. LIDAR, millimeter-wave radar, and laser radar include scanning-type devices that scan pulsed electromagnetic waves (infrared rays, millimeter waves, and the like) to measure scattered light by an object to be measured. These devices can calculate the distance to the respective reflection points of the object by the time (time-of-flight) it takes for the irradiated electromagnetic waves to be reflected and detected by the object. Therefore, the distance sensor 17 includes an electromagnetic wave radiation device and an electromagnetic wave detection device. LIDAR, the millimeter-wave radar, and the laser radar are not limited to the scanning type, and may be flash-type devices. The ultrasonic sensor detects the presence or absence of an object and the distance to the object by oscillating an ultrasonic wave in a detection range by a wave transmitter and receiving the reflected wave by a wave receiver. The stereo camera captures an image of an object using a plurality of cameras arranged in parallel and equal positions, and calculates a distance based on the principle of triangulation from the parallax of an image captured by the camera. The distance sensor 17 is not limited to the above, and various devices capable of performing distance measurement may be employed.

The notification unit 18 includes one or more means for notifying the driver of the vehicle 10 of an alarm. For example, the notification unit 18 may notify the driver of the warning information using the speaker of the vehicle 10. Speakers convert audio signals into physical vibrations to produce sound in space. The notification unit 18 may generate a human voice based on the text information representing the warning information and output the generated voice from the speaker. The speaker may be a speaker for audio installed in the vehicle 10. Further, the notification unit 18 may display the warning information using a display provided in the vehicle 10. The display may employ a variety of displays such as. for example, Liquid Crystal Display (LCD), Electro-Luminescence displays, or mineral EL displays. The display may also be Head Up Display (HUD).

The navigation system 19 is a system that guides a route toward a destination to a driver of the vehicle 10. The driver registers the destination in the navigation system 19 in advance. The navigation system 19 determines a route toward the target according to various conditions set by the driver, and guides the route to the driving driver using a speaker and a display. The navigation system 19 may use the road map information stored in the storage unit 13 and the position information detected by the position detection unit 14.

As illustrated in FIG. 2, the vehicle 10 can communicate with an external traffic information providing system 30 via the network 40. However, unlike FIG. 2, the vehicle 10 may not pass through the network 40, and the traffic information providing system 30 may receive, for example, traffic information transmitted from a broadcasting station on a broadcast wave by FM multiplex broadcasting.

The vehicle 10 can acquire traffic information from the traffic information providing system 30. The traffic information includes information on occurrence of traffic disturbance such as traffic congestion, road obstacles, road construction, accidents, road surface freezing, rainfall, snow cover, and heavy fog. The traffic information includes information on a place where a traffic disturbance has occurred. As a structure of the road, there is a case where there are roads of different road types in the same place due to the grade separation of an expressway or a toll road and a general road. The information on the location where the traffic disturbance has occurred may include the location where the traffic failure has occurred and information on the road type.

The traffic information providing system 30 is operated by an organization that provides traffic information. Organizations that provide traffic information include government agencies that have jurisdiction over traffic management, road managers, and businesses that provide traffic information. In Japan, the organizations that provide traffic information include Japan Road Traffic Information Center (JARTIC), the Road Traffic Information and Communications Systems Center (VICS Center), and the highway companies.

The network 40 for connecting the vehicle 10 and the traffic information providing system 30 includes the Internet, Virtual Private Network (VPN) and a dedicated network 40 provided by a communication carrier. Methods for connecting vehicle 10 and network 40 may include, but are not limited to, a third generation mobile communication system (3G), a fourth-generation mobile communication system (4G) such as LTE, a fifth-generation mobile communication system (5G), Wi-Fi, and Worldwide Interoperability for Microwave Access (WiMAX).

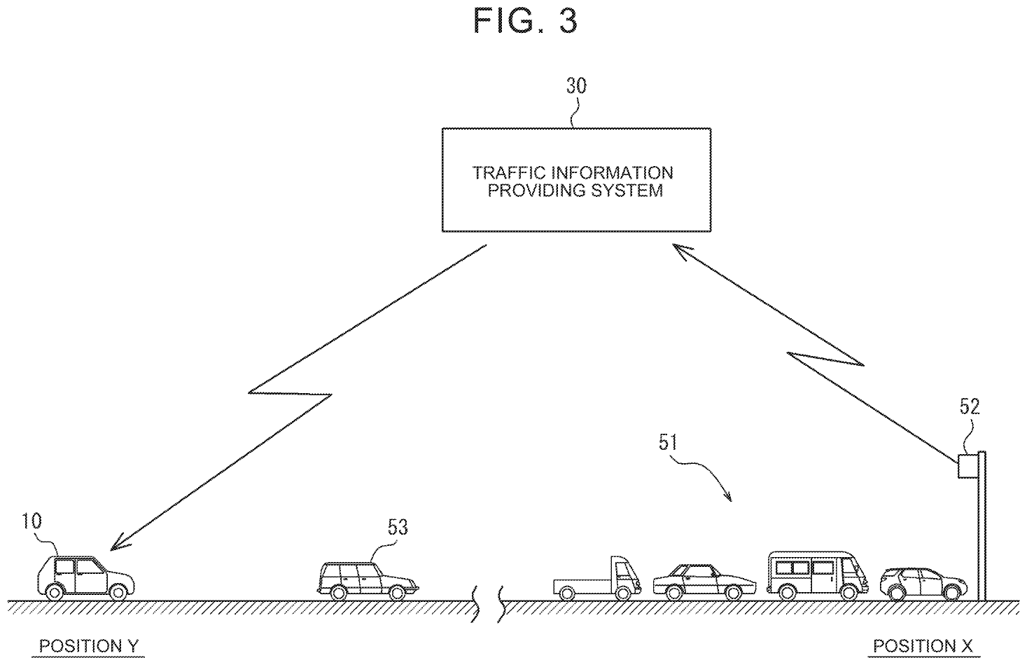

Next, a process executed by the vehicle control device 12 of the vehicle 10 will be described with reference to FIG. 3. FIG. 3 illustrates the vehicle 10 located at the position Y in the case where the traffic disturbance 51 occurs at the position X. In FIG. 3, a traffic disturbance 51 is a traffic jam. It is assumed that a certain distance is provided between the position X and the position Y, and the influence of the traffic disturbance 51 generated at the position X does not extend to the position Y. In the following description, the position X may be referred to as “occurrence position X”. It should be noted that, for traffic disturbances other than traffic congestion, the flow of the vehicle is congested at the location where the traffic obstacle occurs, and thus traffic congestion or stagnation of a plurality of vehicles occurs. Therefore, in many cases, the vehicle is forced to decelerate around the occurrence position X where the traffic disturbance occurs.

A number of various traffic sensors 52 are arranged around the road to collect traffic information. The traffic sensor 52 may include various types. For example, the traffic sensor 52 is a camera that is attached to a structure beside a road or above a road and captures an image of the condition of the road. The traffic sensor 52 may extract a vehicle on the road from an image of the camera and detect a degree of congestion and/or a traveling speed of the vehicle. The traffic sensor 52 also includes a loop coil sensor or a magnetic sensor that counts vehicles buried and passing through the road.

The traffic sensor 52 transmits the information collected around the road to the traffic information providing system 30. In addition, information such as an accident occurring on a road is collected in the traffic information providing system 30. In the traffic information providing system 30, some of the traffic information is input directly or manually from a terminal located at a remote location. By collecting these pieces of information, the traffic information providing system 30 can manage wide-area traffic information.

When a traffic disturbance 51 occurs on a road, the traffic information providing system 30 can notify the vehicle 10 traveling on the road of the occurrence of the traffic disturbance 51 by various methods. For example, the traffic information providing system 30 may notify the vehicle 10 of the occurrence of the traffic disturbance 51 via a bidirectional communication system through the network 40 and/or a unidirectional communication system using broadcast waves. Further, for example, the traffic information providing system 30 can transmit traffic information to the vehicle 10 from an information transmitting device installed on a road. The information transmission device includes, for example, a device called “radio beacon” and “optical beacon” in Japan. A scheme using an information transmitting device is advantageous for transmitting local information, such as notifying the occurrence of a traffic disturbance 51 on a specific road.

When the vehicle control device 12 of the vehicle 10 receives the information on the traffic disturbance 51 from the traffic information providing system 30, it checks whether the traffic disturbance 51 that is occurring is occurring on the road on which the own vehicle is going to travel. The vehicle control device 12 of the vehicle 10 executes control in which the influence of the occurrence of the traffic disturbance 51 is read ahead as the position X where the traffic disturbance 51 has occurred approaches, when the traffic disturbance 51 is occurring on the route through which the vehicle 10 passes.

For example, the vehicle control device 12 calculates a reference inter-vehicle distance corresponding to the speed when a traffic disturbance occurs in front of the route of the vehicle 10, and sets the distance from the preceding vehicle 53 to be larger than the reference inter-vehicle distance. In particular, the vehicle control device 12 increases the reference inter-vehicle distance before the deceleration of the vehicle due to the influence of the traffic disturbance occurs. For example, when a traffic disturbance occurs in front of a route while the vehicle 10 is traveling on an expressway at a 100 m speed per hour, the vehicle control device 12 may set the reference inter-vehicle distance to 150 m when the inter-vehicle distance to be normally safe is about 100 m. The vehicle control device 12 controls the vehicle 10 so as to prompt the driver to decelerate or decelerate the speed in order to keep the reference inter-vehicle distance. As a result, the vehicle 10 can decelerate quickly to increase the inter-vehicle distance from the preceding vehicle 53. In this way, in a case where the road becomes congested due to the proximity to the occurrence position (position X) where the traffic disturbance occurs, the danger of rapid deceleration or collision with the preceding vehicle 53 can be avoided.

In general, it is known that a sudden deceleration of a vehicle traveling on a road causes deterioration of traffic congestion. When an accident or the like suddenly causes a place where a traffic flow slows down, a vehicle traveling on a road in front of the accident or the like suddenly decelerates, so that a traffic jam spreads backward. The vehicle 10 equipped with the vehicle control device 12 of the present disclosure is able to reduce the degree of deceleration at the location of the traffic disturbance 51 by traveling with a reference inter-vehicle distance or more between the vehicle and the preceding vehicle 53 sufficiently in front of the traffic disturbance 51. Therefore, by including the vehicle 10 on which the vehicle control device 12 of the present disclosure is mounted at a constant rate in the vehicle traveling on the road, it can be expected to contribute to alleviation of the traffic jam on the road where the traffic disturbance 51 has occurred.

According to this method, the vehicle control device 12 of the vehicle 10 autonomously controls the traveling of the vehicle 10 based on the information of the traffic disturbance 51 generally provided as the traffic information without depending on the control from an external computer such as a traffic management center. Therefore, according to the present method, it is not necessary to arrange a computer that performs central processing for controlling a large number of vehicles.

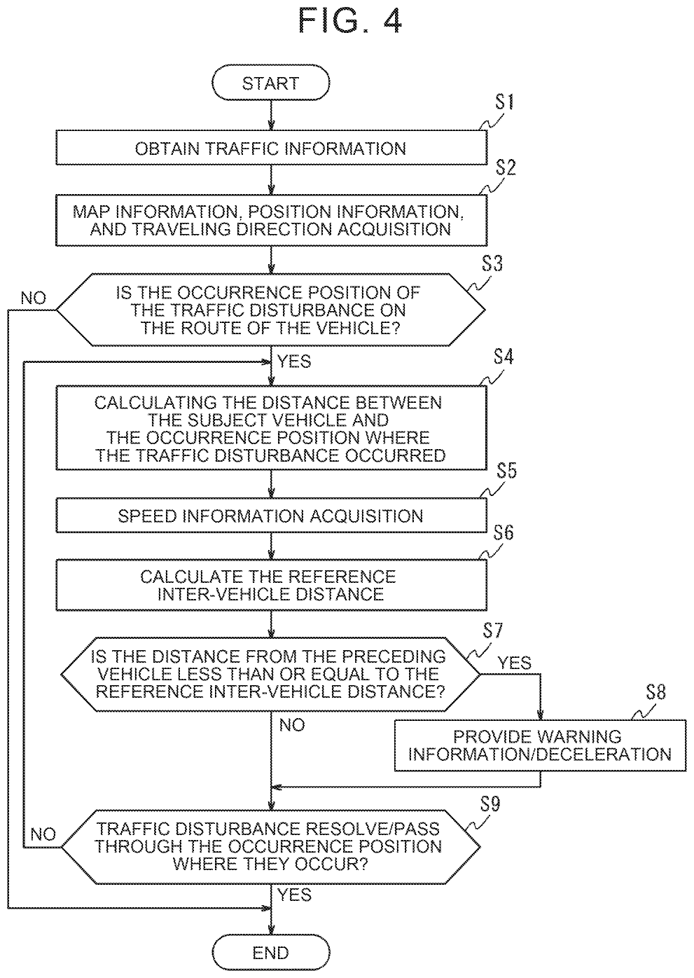

Next, a procedure of a process executed by the control unit 20 of the vehicle control device 12 will be described with reference to FIG. 4. The processing method disclosed in this specification may be executed by a processor included in the control unit 20 according to a program. Such a program can be stored in a non-transitory computer-readable medium. Examples of the non-transitory computer-readable medium include hard disks, RAMS, ROMs, flash memories, compact disc (CD)-ROMs, optical storage devices, magnetic storage devices, and the like, but are not limited to these. The process executed by the control unit 20 will be described below as the process of the vehicle control device 12.

First, the vehicle control device 12 of the traveling vehicle 10 acquires traffic information from the traffic information providing system 30 via the communication unit 11 (S1). The traffic information includes information on the position X where the traffic disturbance 51 has occurred.

The vehicle control device 12 that has acquired the traffic disturbance information acquires the road map information of the road on which the vehicle is traveling. the position information indicating the present position (position Y) of the vehicle 10, and the information on the traveling direction (S2). The vehicle control device 12 can acquire the road map information, the position information, and the information on the traveling direction from the storage unit 13, the position detection unit 14, and the azimuth sensor 15, respectively. By continuously acquiring the road map information, the position information of the vehicle 10, and the information on the traveling direction, the vehicle control device 12 can recognize which road on the road map the vehicle 10 is traveling on and which direction of the road is traveling. When the navigation system 19 constantly acquires and manages these pieces of information, the vehicle control device 12 may acquire these pieces of information from the navigation system 19.

Next, the vehicle control device 12 determines whether or not the position X where the traffic disturbance 51 is occurring is on the route of the vehicle 10 (S3). For example, in a case where the vehicle 10 is located on the expressway and the position X at which the traffic disturbance 51 occurs is ahead of the vehicle 10 on the same expressway in the traveling direction, the position X at which the traffic disturbance 51 occurs is determined to be on the route of the vehicle 10 from the road map information, the position information, and the information on the traveling direction. Further, for example, when the driver of the vehicle 10 is using the navigation system 19, it is possible to determine, from the route in the guidance of the navigation system 19, whether or not the position X where the traffic disturbance 51 is occurring is on the route on which the vehicle 10 is going to travel from now on.

When the occurrence position of the traffic disturbance 51 is not located on the route of the vehicle 10 in S3 (S3: No), the process described below is not executed. When the occurrence position X of the traffic disturbance 51 is on the route of the vehicle 10 in S3 (S3: Yes), the vehicle control device 12 calculates the distance between the vehicle 10 and the occurrence position X where the traffic disturbance 51 is occurring (S4). This distance may be the distance on the path of travel. The vehicle control device 12 can calculate the distance on the route from the vehicle 10 to the occurrence position X of the traffic disturbance 51 by using the road map information.

Next, the vehicle control device 12 acquires speed information of the vehicle 10 (S5). The speed information is obtained from the speed sensor 16 of the vehicle 10.

The vehicle control device 12 calculates the reference inter-vehicle distance from the distance between the vehicle 10 calculated by S4 and the occurrence position X at which the traffic disturbance 51 occurs and the velocity of the host vehicle 10 (S6). Since the reference inter-vehicle distance is provided for the case where the vehicle 10 has to decelerate due to a sudden traffic jam, the reference inter-vehicle distance is set to a distance longer than a distance that is set as an appropriate inter-vehicle distance when the normal vehicle is traveling. The vehicle control device 12 calculates a relatively wider reference inter-vehicle distance even when the vehicle is relatively far from the occurrence position X of the traffic disturbance 51 and the deceleration due to the influence of the traffic obstacle does not occur.

The vehicle control device 12 acquires the distance between the vehicle 10 and the preceding vehicle 53, and determines whether the distance is equal to or less than the reference inter-vehicle distance (S7). The vehicle control device 12 acquires the distance between the vehicle 10 and the preceding vehicle 53 from the distance sensor 17.

When the distance from the preceding vehicle 53 is equal to or less than the reference inter-vehicle distance (S7: Yes), the vehicle control device 12 uses the notification unit 18 to warn the driver or controls the vehicle 10 to decelerate (S8). For example, the vehicle control device 12 causes the notification unit 18 to issue a message prompting deceleration from the speaker. Further, for example, the vehicle control device 12 controls a braking Electronic Control Unit (ECU) for controlling braking of the vehicle 10 to decelerate the vehicle 10 to increase the inter-vehicle distance to the reference inter-vehicle distance. The notification of S8 warning information and/or the deceleration control of the vehicle may be selected by the driver in advance by setting. For example, level 1 may be a voice-only warning, level 2 may be a deceleration control of the vehicle, level 3 may be a voice warning and a deceleration control of the vehicle, and the driver may select any of level 1 to level 3 in advance.

When the distance from the preceding vehicle 53 exceeds the reference inter-vehicle distance in S7 (S7: No), the process of the vehicle control device 12 proceeds to the following S9.

The vehicle control device 12 repeats S9 from S4 as long as either the notification that the traffic disturbance 51 has been resolved is received from the traffic information providing system 30 or the traffic disturbance 51 passes through the occurrence position X is not satisfied (S9: No). The vehicle control device 12 terminates the process related to the traffic information received in S1 when either one of the followings is satisfied (S9: Yes): the notification that the traffic disturbance 51 has been resolved is received from the traffic information providing system 30, and the occurrence position of the traffic disturbance 51 has been passed through.

As described above, since the vehicle control device 12 of the present disclosure calculates the reference inter-vehicle distance based on the distance between the position Y of the vehicle 10 and the occurrence position X of the traffic disturbance 51 and the speed information, the inter-vehicle distance corresponding to the sudden traffic jam associated with the traffic disturbance 51 can be calculated. According to the vehicle control device 12, it is possible to avoid the rapid deceleration of the vehicle 10 in the vicinity of the place where the traffic failure occurs by widening the reference inter-vehicle distance even at a position away from the position X where the traffic disturbance 51 has occurred. Therefore, the safety of the driver of the vehicle 10 is improved. Further, the vehicle control device 12 can suppress the spread of the traffic jam at the position X where the traffic disturbance 51 occurs and absorb and mitigate the influence of the traffic jam by not performing the rapid deceleration. Further, in the method of the present disclosure, since the vehicle control device 12 of each vehicle 10 receives the traffic information and makes its own determination, there is no need to provide a computer for traffic control at any place.

Further, when the inter-vehicle distance is shorter than the reference inter-vehicle distance, the vehicle control device 12 notifies the driver of the vehicle 10 of the warning information by the notification unit in the vehicle 10. Further, the vehicle control device 12 may control the vehicle to decelerate when the inter-vehicle distance is shorter than the reference inter-vehicle distance. That is, the vehicle control device 12 can deal with both the case where the driver of the vehicle 10 wants to drive the vehicle 10 himself/herself and the case where the driver performs the driving at least partially supported by the system of the vehicle.

Further, in the process of acquiring the road type of the road on which the vehicle 10 is traveling and determining whether or not the occurrence position X of the traffic disturbance 51 is on the route on which the vehicle 10 travels, the vehicle control device 12 considers the coincidence or inconsistency between the road type of the road through which the vehicle 10 passes and the road type of the occurrence position of the traffic disturbance 51. Accordingly, the vehicle control device 12 has high convenience even in a road environment in which a plurality of types of roads such as a general road and an expressway coexist at the same location.

In addition, the vehicle control device 12 of the present disclosure can deal with information of various types of traffic disturbance 51 including traffic jams, road obstacles, road construction, accidents, road surface freezing, rainfall, snow cover, and fog.

Further, since the vehicle control device 12 of the present disclosure can increase the reference inter-vehicle distance before the deceleration of the vehicle 10 occurs due to the influence of the traffic disturbance, it is possible to achieve a large effect by avoiding the rapid deceleration of the vehicle 10 and alleviating the traffic jam.

It should be noted that the present disclosure is not limited to the above-described embodiments, and many modifications and variations are possible. For example, the functions included in each means, each step, etc. can be rearranged so as not to be logically inconsistent, and a plurality of means, steps, etc. can be combined into one or divided.

What is claimed is:

1. A vehicle control device mounted on a vehicle, the vehicle control device comprising a control unit, wherein the control unit is configured to:
be able to acquire a road map information, position information indicating a position of the vehicle, a traveling direction of the vehicle, speed information of the vehicle, and traffic information;
determine, when acquiring the traffic information including information of an occurrence position of a traffic disturbance, whether the occurrence position is on a route on which the vehicle travels, based on the road map information, the position information, and the traveling direction; and
execute a process of calculating a reference inter-vehicle distance based on a distance between the position of the vehicle and the occurrence position, and the speed information.

2. The vehicle control device according to claim 1, wherein the control unit acquires an inter-vehicle distance between the vehicle and a vehicle traveling in front of the vehicle, and when the acquired inter-vehicle distance is shorter than the reference inter-vehicle distance, provides warning information to a driver of the vehicle by a notification unit in the vehicle.

3. The vehicle control device according to claim 2, wherein the control unit performs control such that the vehicle decelerates when the inter-vehicle distance is shorter than the reference inter-vehicle distance.

4. The vehicle control device according to claim 1, wherein the control unit acquires a road type of a road on which the vehicle is traveling, and factors in a match or a mismatch between the road type and a road type of the occurrence position of the traffic disturbance in a process of determining whether the occurrence position is on the route on which the vehicle travels.

5. The vehicle control device according to claim 1, wherein the traffic disturbance includes at least one of a traffic jam, a road obstacle, a road construction, an accident, a road surface freezing, rainfall, snow accumulation, and a heavy fog.

6. The vehicle control device according to claim 1, wherein the control unit increases the reference inter-vehicle distance before the vehicle decelerates due to an influence of the traffic disturbance.
